(19) United States
(12) Patent Application Publication
(10) Pub. No.: US 2007/0192693 A1
(43) Pub. Date: Aug. 16, 2007

(54) Apparatus and method for controlling key events when handling a graphics object

(75) Inventors: Do-youn Kang, Suwon-si (KR); Jang-seok Seo, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/648,675

(22) Filed: Jan. 3, 2007

(30) Foreign Application Priority Data
Feb. 10, 2006 (KR) 10-2006-0013265

(51) Int. Cl. G06F 9/46

(52) U.S. Cl. 715/702; 713/502; 719/318

(57) ABSTRACT

An apparatus and a method for controlling key events generated when handling a graphics object are provided. The apparatus includes an event-determining unit that determines a type of an event; an event-managing unit that determines execution of the event depending on the determined type of the event; and a count-checking unit that checks an event count that indicates a number of predetermined event occurrences and a number of times the graphics object has been handled, according to the request of the event-managing unit.

### CROSS-REFERENCE TO RELATED APPLICATION

This application claims priority from Korean Patent Application No. 10-2006-0013265 filed on Feb. 10, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to controlling key events generated while handling a graphics object, and more particularly, to reducing a screen-update delay when a graphics object is displayed, by not executing key events generated while display events are executed.

2. Description of the Related Art

As functions of electronic appliances become more complicated, a windowing system is used in order to effectively output a graphics object on a screen.

Various products, such as digital televisions (TVs) and refrigerators, provide graphical interfaces to a user, which makes it easier for the user to use the products. Hence, the windowing system which exhibits good graphical performance has been applied to electronic appliances.

Generally, the windowing system communicates with an application program using events, and because a handler on the events is defined, the application program can be operated in the windowing system.

Hence, unlike a program having a procedural structure, the window program is referred to as an event-driven or message-driven program.

FIG. 1 illustrates a structure of a window application program according to a related art.

As illustrated, a window application program (hereinafter, called an “application program”) 10 includes a message loop 12 and a window procedure 13, which are handled in their respective programs. Generally, the application program 10 consists of at least one window and a main window. Further, if several windows are used in the application program 10, messages generated in each window are transferred to the window procedure 13 via the message loop 12.

If the application program having a window is executed, one message queue 11 is allocated to each application program 10. Then, if an event occurs in the window in each application program 10, a window operating system inserts the generated message (event) into the message queue 11 of the application program 10. Here, the application program 10 handles the message transmitted by the window operating system in the message loop 12, and hands the message over to the window procedure 13. Then, a predetermined routine is executed in order to handle the message in the window procedure 13.

In the case where a graphics object is displayed on the screen, an event of the object occurs, and each object is displayed on the screen by the window procedure 13. Here, in the case where a plurality of objects are displayed on a system having limited performance, a display interval of the objects can be visually recognized depending on an event interval or handling ability of the window procedure 13. In order to prevent such recognition, a double-buffering method is used.

The double-buffering does not directly display a graphics object on a screen, but first stores the object in a buffer (memory), then later displays the object on the screen.

However, in applying the double-buffering, if the main window and a lower-layer window are not output on the screen by one thread, it is hard to capture the point when the windows are all displayed in the buffer, because the output order is not clear.

Further, in the case where a user wants to move a graphics object via key input, if the user keeps pressing a direction key to obtain a desired result, corresponding commands accumulate. Here, the window procedure 13 executes the accumulated commands in order, and the graphics object, which has been moved to the final position, is displayed on the screen.

In other words, as illustrated in FIG. 2, in the state where display events are being executed, if a key event on a graphics object 20 occurs due to user's key input, because the number of event occurrences and the number of event executions are not the same and the display events and the key event are executed at the same time, the movement process of the graphics object 20 is not shown on a screen. Then, at a certain point of time, i.e. the moment the number of event occurrences and the number of event executions become the same, the updated state is suddenly displayed on the screen, which causes a problem of screen update delay.

Hence, the user expects to see the movement process of the graphics object 20 by key selection, but in the related art, only the moved result of the graphics object 20 according to the key selection of the user is displayed on the screen by the update delay.

Korean Patent Laid-Open Publication No. 2004-0055116 (Method and System for Moving Object in Digital TV) discloses a method that displays digital broadcasting received from a digital-TV-signal-receiving unit, and re-displays the position of an EPG object displayed on a screen according to a remote-control operation of a user, but does not disclose a method that controls a key event generated in the state where the movement of the previous event, i.e. the display event, is not completed.

### SUMMARY OF THE INVENTION

The present invention provides a method and apparatus for controlling key events generated while handling a graphics object, which reduces a screen update delay when a graphics object is displayed, by not executing key events generated while display events are executed.

According to an aspect of the present invention, there is provided an apparatus for controlling key events generated when handling a graphics object, the apparatus including an event-determining unit that determines a type of an event; an event-managing unit that determines execution of the event depending on the determined type of the event; and a count-checking unit that checks an event count that indicates a number of predetermined event occurrences and a number of times the graphics object has been handled, according to the requests of the event-managing unit.

According to another aspect of the present invention, there is provided a method of controlling key events generated when a graphics object is handled, the method including determining a type of an event when the event occurs; checking an event count, if the determined type of the event is a key event; executing the event, if the event count is not larger than a predetermined value as a result of the checking; storing the graphics object of the executed event; and displaying the stored graphics object, when the executing of the event is completed.

### BRIEF DESCRIPTION OF THE DRAWINGS

The above and other aspects of the present invention will become apparent by describing in detail exemplary embodiments thereof with reference to the attached drawings, in which:

FIG. 1 illustrates a structure of a window application program according to a related art.

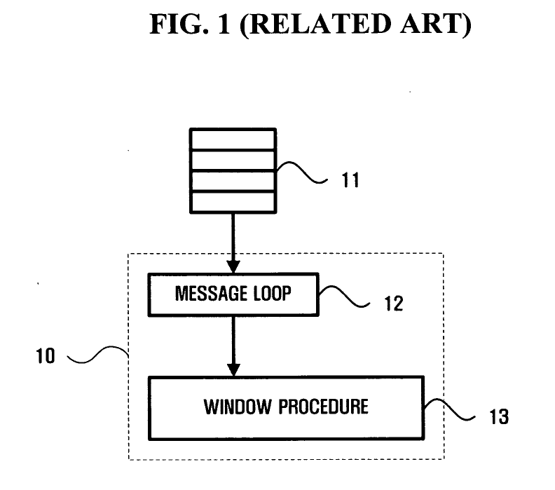

FIG. 2 illustrates an execution process of display events according to the related art and a desired execution process of display events.

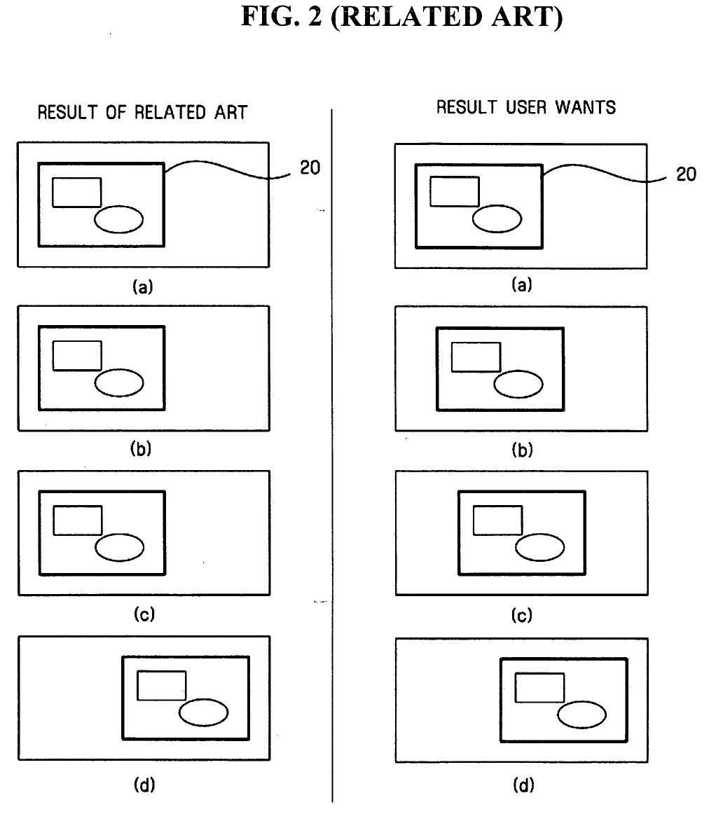

FIG. 3 is a block diagram illustrating an apparatus for controlling key events generated when handling a graphics object according to an exemplary embodiment of the present invention.

FIG. 4 is a flow chart illustrating a method of controlling key events generated when handling a graphics object according to an exemplary embodiment of the present invention.

FIG. 5 illustrates a case of displaying a plurality of windows using one variable in controlling key events generated when handling a graphics object according to an exemplary embodiment of the present invention.

FIG. 6 illustrates a case of displaying a plurality of windows using a plurality of variables when controlling key events generated when handling a graphics object according to an exemplary embodiment of the present invention.

### DETAILED DESCRIPTION OF EXEMPLARY EMBODIMENTS OF THE INVENTION

Exemplary embodiments of the present invention will be described in detail with reference to the accompanying drawings.

Advantages and features of the present invention and methods of accomplishing the same may be understood more readily by reference to the following detailed description of the exemplary embodiments and the accompanying drawings. The present invention may, however, be embodied in many different forms and should not be construed as being limited to the embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

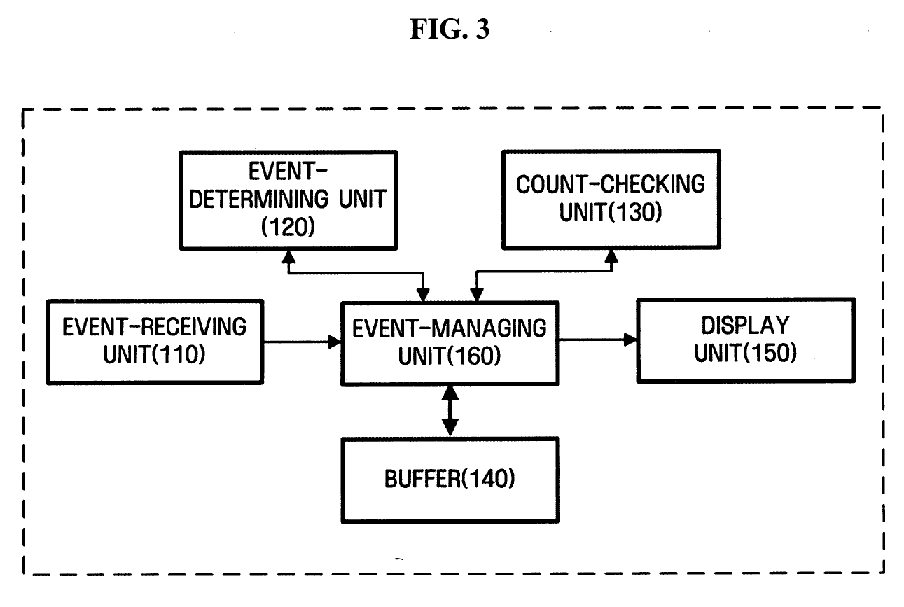

FIG. 3 is a block diagram illustrating an apparatus for controlling key events generated when handling a graphics object according to an exemplary embodiment of the present invention.

As illustrated, an apparatus for controlling key events generated when handling a graphics object includes an event-receiving unit 110, an event-determining unit 120, a count-checking unit 130, a buffer 140, a display unit 150, and an event-managing unit 160.

In the embodiment of the present invention, the term “unit,” as used herein, means, but is not limited to, a software or hardware component, such as a Field Programmable Gate Array (FPGA) or an Application Specific Integrated Circuit (ASIC), which performs certain tasks. A unit may advantageously be configured to reside in the addressable storage medium and to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units. In addition, the components and units may be implemented so as to execute one or more Central Processing Units (CPUs) in a device.

The event-receiving unit 110 is input an event command generated by a user. Here, the event command refers to a display event that requests display of a predetermined graphics object and a key event that requests movement of a displayed graphics object in the predetermined direction.

The event-determining unit 120 determines a type of event received by the event-receiving unit 110. Here, the type of event is determined because an event execution is determined according to the type of input event.

For example, in the case where a key event is inputted while a display event is in progress, the event-managing unit 160 does not execute the inputted key event, and if the display event is not in progress, the newly input event is executed regardless of the type of the event.

Further, if a new display event is input while a display event is in progress, the event-managing unit 160 controls the event to be executed.

Here, the graphics object is at least one among a window, a frame, a dialogue, a button, a check box, a radio box, a list, a scroll bar, and a menu bar, and each graphics object is handled according to the event generated by a thread. Here, because each graphics object can belong to a different thread or a different process, respectively, the point when the event is executed cannot be calculated accurately.

An application program generally comprises of one or more windows, and has a message loop and a window procedure. Further, one or more message queues are allocated to each application program. In most cases, one message queue is allocated to each message loop.

Then, if an event on the display of a graphics object occurs in a window of the application program, a window operating system or a window manager inserts the generated message into the message queue of the application program. The event-determining unit 120 confirms whether a predetermined event has been output from the message queue, and determines whether the output event is a display event or a key event.

Here, the application program, which received the message, executes the message transmitted by the window operating system in the message loop, and hands the message over to the window procedure. The message on the display of the graphics object handed over to the window procedure and the message on the movement of the graphics object are executed by an appropriate processing routine.

The count-checking unit 130 checks the number of event occurrences determined by the event-determining unit 120, and the number of times the graphics object has been handled in the window procedure.

For example, the count-checking unit 130 confirms the number of event occurrences and the number of times the graphics object has been handled using a variable stored in a separate area, then transmits the event count value, which is a result of the confirmation, to the event-managing unit 160.

In other words, the event-receiving unit 110 increases the variable by 1 whenever receiving a generated event, and decreases the variable by 1 whenever the graphics object is handled by the window procedure. The point when the variable becomes 0 can be understood as the point when the handling of all graphics objects to be displayed on a screen has been completed.

Hence, the count-checking unit 130 checks the number of times the graphics object has been handled at each predetermined event occurrence, and transmits the checked value according to the request of the event-managing unit 160.

The buffer 140 temporarily stores a graphics object which has been handled in the window procedure according to received events confirmed by the event-receiving unit 110. Here, the storing does not simply refer to storing data of the graphics object in a memory, but refers to the state where a memory on an area for outputting in the screen is allocated, and the graphics object is drawn in the memory, in which the graphics object is not output only on the screen.

The display unit 150 displays the graphics object stored in the buffer 140 on the screen. Here, the display unit 150 displays a plurality of graphics objects, which are executed and stored, at the same time.

The event-managing unit 160 determines execution of an event depending on the type of the event determined by the event-determining unit 120.

For example, in the case where an event transmitted from the event-determining unit 120 is a key event, an event count (i.e. a variable) is checked by the count-checking unit 130, and as a result of the checking, if the event count value is not 0, i.e. if the current display event is in progress, the event-managing unit 160 does not execute the input key event.

On the other hand, as a result of the checking, if the event count value 0, i.e. if the current display event is not in progress, the event-managing unit 160 handles the key event.

Further, in the case where an event transmitted from the event-determining unit 120 is a display event, the event-managing unit 160 executes the display event.

Further, if information that the handling of all graphics objects has been completed is transmitted through the count-checking unit 130, the event-managing unit 160 displays graphics objects stored in the buffer 140 at the same time via the display unit 150. Here, the point when the handling of all graphics objects is completed is the point when the event count (i.e. the variable) becomes 0.

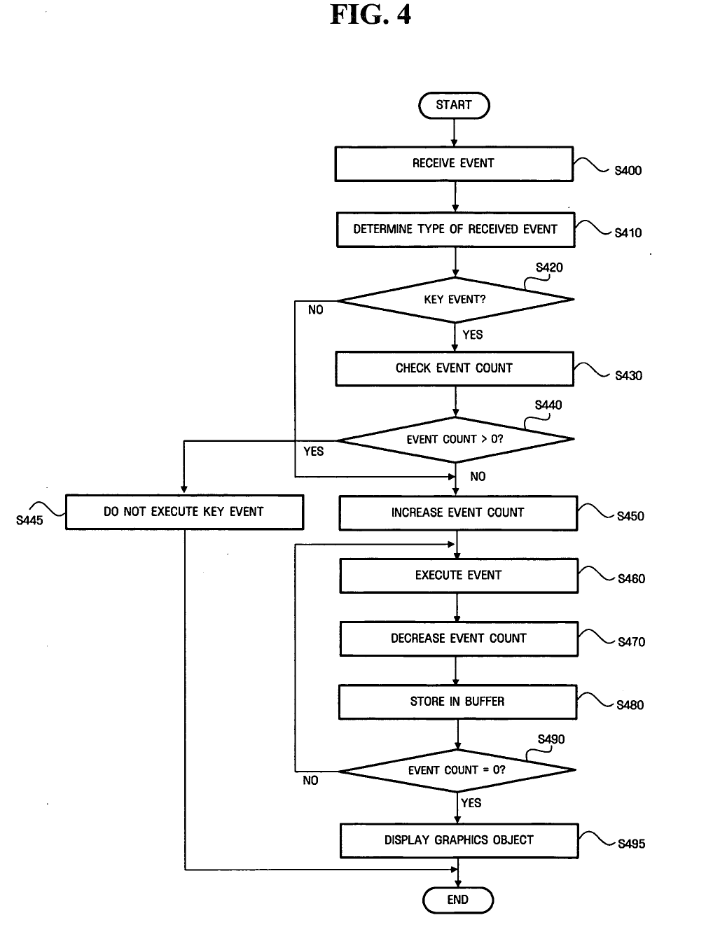

FIG. 4 is a flow chart illustrating a method of controlling key events generated when handling a graphics object according to an exemplary embodiment of the present invention.

First, if an event occurs about the display of a graphics object, such as the case where an application program is initially executed or the case where a certain area of a main window should be re-drawn occurs, the window operating system inserts the generated event into a message queue of the application program. Further, in the case where a user wants to move a graphics object displayed on a screen, the user selects a predetermined direction key, and generates a key event.

As such, the event-receiving unit 110 receives a generated event command (e.g. a display event and a key event) (S400), and transmits the received event to the event-determining unit 120.

Then, the event-determining unit 120 determines the type of the event transmitted from the event-receiving unit 110 (S410), and transmits the result of the determination to the event-managing unit 160. Here, the type of event is determined because an event execution is determined depending on the type of the input event.

As a result of the determination, if the input event is a key input event (S420), the event-managing unit 160 checks an event count (i.e. the number of event occurrences and the number of times the graphics object has been handled in the window procedure) through the count-checking unit 130 (S430).

As a result of the checking, if the event count (i.e. the variable) is not larger than 0 (S440), the event-managing unit 160 determines that there is no event in progress. Here, the count-checking unit 130 increases a variable set in a separate area about the number of key event occurrences by 1, and stores the variable (S450).

Then, the event-managing unit 160 executes the event (S460). Here, execution of an event refers to movement of the graphics object displayed on the screen in a predetermined direction. Then, when the execution of the event is completed, the event-managing unit 160 informs the count-checking unit 130 of the completion of the event execution, then the count-checking unit 130 decreases a variable set in a separate area about the number of times the key events have been executed by 1, and stores the variable (S470).

Then, the event-managing unit 160 stores the execution-completed graphics object in the buffer 140 (S480), and requests the count-checking unit 130 to check an event count in order to determine if an event is in progress.

Then, the count-checking unit 130 checks whether the event count (i.e. the variable) is 0 (S490), and as a result of the checking, if the variable is 0, the event-managing unit 160 displays a graphics object stored in the buffer 140 on the screen through the display unit 150 (S495). Here, the point when the variable becomes 0 can be understood as the point when the execution of all graphics objects to be displayed on the screen has been completed.

Further, as a result of the checking of the count-checking unit 130, if the variable is not 0 (S490), the event-managing unit 160 determines that there exits a display event in progress, and makes uncompleted display events completed. In other words, operations S460 to S480 are re-performed.

Further, the count-checking unit 130 checks the value of the event count in order to execute the key event, and as a result of the checking, if the event count (i.e. the variable) is larger than 0 (S440), the event-managing unit 160 determines that there exits a display event in progress, and does not execute the received key event (S445).

Further, as a result of determination of the event-determining unit 120, if an event transmitted from the event-receiving unit 110 is a display event (S420), the event-managing unit 160 executes the display event. That is, the count-checking unit 130 increases by 1 a variable that is set in a separate area about the number of display event occurrences, and stores the variable (S450). Then, operations S460 to S495 are performed in the same way.

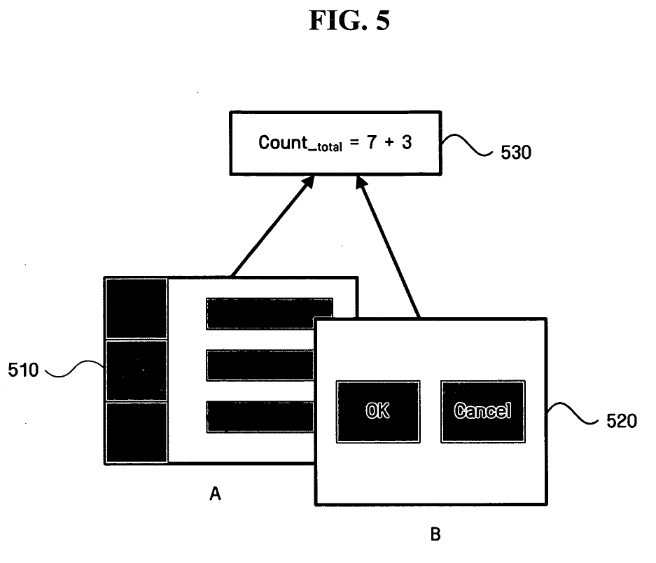

FIG. 5 illustrates a case of displaying a plurality of windows using one variable in controlling key events generated when handling a graphics object according to an exemplary embodiment of the present invention.

A plurality of windows can be displayed by one or more application programs, and FIG. 5 illustrates the case where a plurality of windows 510 and 520 are displayed using one variable 530.

The window A 510 consists of 1 main window and 6 buttons making a total of 7 graphics objects, and the window B 520 consists of 1 main window and 2 buttons making a total of 3 graphics objects.

Here, a variable is set as a global variable (Count_{—total}) in order to manage the number of event occurrences for each window and the number of times a graphics object is handled.

If an event occurs, which commands to display a graphics object on the window A 510, the child window of the window A 510, the window B 520, or the child window of the window B 520, the event-determining unit 120 checks whether an event on the display of the graphics object has been generated.

As a result of the checking, if an event occurrence is confirmed, the Count_{—total} 530 is increased by 1, and if the graphics object is executed by the window procedure, the Count_{—total} 530 is decreased by 1.

The value of the global variable Count_{—total} 530 is calculated regardless of the window, and before the result becomes 0, the window A 510, the child window of the window A 510, the window B 520, and the child window of the window B 520 are stored in the buffer 140, and are not displayed on a screen. The window A 510, the child window of the window A 510, the window B 520, and the child window of the window B 520 are displayed at the same time at the point when the result of the Count_{—total} 530 becomes 0.

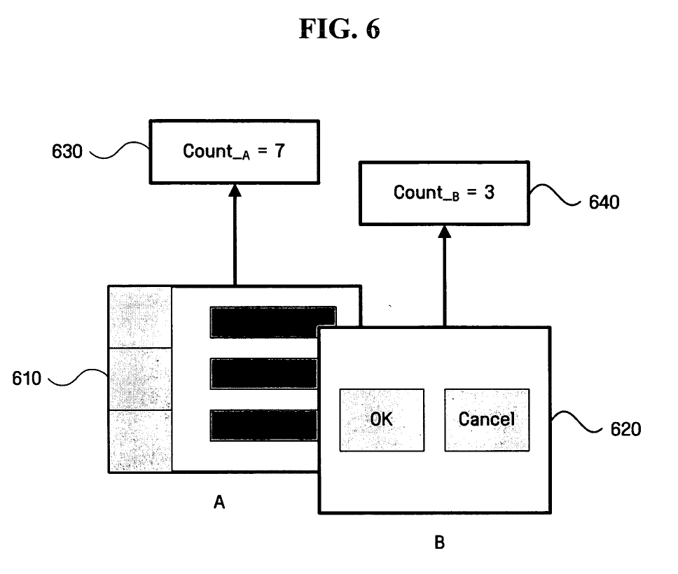

FIG. 6 illustrates a case of displaying a plurality of windows using a plurality of variables in controlling key events generated when handling a graphics object according to an exemplary embodiment of the present invention.

A plurality of windows can be displayed by one or more application programs, and FIG. 6 illustrates the case where a plurality of windows 610 and 620 are displayed using a plurality of variables 630 and 640.

The window A 610 consists of 1 main window and 6 buttons, totally 7 graphics objects, and the window B 620 consists of 1 main window and 2 buttons, totally 3 graphics objects.

Here, a variable is set as a local variable (Count_{—A} or Count_{—B}) in order to manage the number of event occurrences for each window and the number of times a graphics object is handled. A local variable Count_{—A} 630 is set to the window A 610, and a local window Count_{—B} 640 is set to the window B 620.

If an event occurs, which commands to display a graphics object on the window A 610, the child window of the window A 610, the window B 620, or the child window of the window B 620, the event-determining unit 120 checks whether an event on the display of the graphics object has been generated.

Here, the count-checking unit 130 determines which window the event corresponds to. If the generated event is the event of the window A 610 or the child window of the window A 610, Count_{—A} 630 is increased by 1, and if the generated event is the event of the window B 620 or the child window of the window B 620, Count_{—B} 640 is increased by 1. When the graphics object is handled by the window procedure, Count_{—A} 630 or Count_{—B} 640 is decreased by 1.

As such, the value of the local variable Count_{—A} 630 or Count_{—B} 640 is calculated according to the window, and the display is determined according to the result of each calculation.

In other words, though the value of the local variable Count_{—A} 630 of the window A 610 is not 0, if the value of the local variable Count_{—B} 640 of the window B 620 is 0, the window A 610 is stored in the buffer 140, and the window B 620 is displayed on the screen by the display unit 150.

It should be understood by those of ordinary skill in the art that various replacements, modifications and changes may be made in the form and details without departing from the spirit and scope of the present invention as defined by the following claims. Therefore, it is to be appreciated that the above described exemplary embodiments are for purposes of illustration only and are not to be construed as limitations of the invention.

According to the exemplary embodiments of the present invention, the delay of screen update when a graphics object is displayed is solved, by not executing key events generated while display events are executed.

Also, according to the exemplary embodiments of the present invention, when accumulated commands prevent the generation of key events, the screen is not continually updated, by not executing key events generated while display events are executed.

What is claimed is:

1. An apparatus for controlling key events generated when handling a graphics object, the apparatus comprising:
an event-determining unit that determines a type of an event;
an event-managing unit that determines execution of the event depending on the determined type of the event; and
a count-checking unit that checks an event count that indicates a number of occurrences of predetermined events and a number of times the graphics object has been handled, according to the request of the event-managing unit.

2. The apparatus of claim 1, wherein the event is one of a display event and a key event.

3. The apparatus of claim 1, wherein, if the determined type of the event is a key event, the event-managing unit determines whether the event should be executed based on the event count checked by the count-checking unit.

4. The apparatus of claim 1, wherein, if the determined type of the event is a display event, the event-managing unit increases the event count, and executes the display event.

5. The apparatus of claim 1, further comprising:
an event-receiving unit that receives an event command;
a buffer that temporarily stores the graphics object of an executed event; and
a display unit that displays the graphics object stored in the buffer on a screen.

6. The method of controlling key events generated when a graphics object is handled, the method comprising:
determining a type of an event when the event occurs;
checking an event count, if the determined type of the event is a key event;
executing the event, if the event count is not larger than a predetermined value as a result of the checking;
storing the graphics object of the executed event; and
displaying the stored graphics object, when the executing of the event is completed.

7. The method of claim 6, wherein the executing comprises:
storing a variable set in a separate area about the number of key event occurrences after increasing the variable by 1; and
storing a variable set in a separate area about the number of times the key events have been executed after decreasing the variable by 1.

8. The method of claim 6, wherein the key event is not executed, if the event count is larger than the predetermined value as the result of the checking.

9. The method of claim 6, wherein the event count is a number of occurrences of predetermined events and a number of executed graphics objects.

10. The method of controlling key events generated when a graphics object is handled, the method comprising:
determining a type of an event when the event occurs;
increasing an event count and executing the event, if the determined type of the event is a display event;
storing the graphics object of the executed event; and
displaying the stored graphics object, when the executing of the event is completed.

11. The method of claim 10, wherein the event count is a number of occurrences of predetermined events and a number of executed graphics objects.
